(19) United States
(12) Patent Application Publication
(10) Pub. No.: US 2022/0368419 A1
(43) Pub. Date: Nov. 17, 2022

(54) POSITIONING, NAVIGATION, AND TIMING USING OPTICAL RANGING OVER FREE SPACE OPTICAL LINKS FOR A CONSTELLATION OF SPACE VEHICLES

(71) Applicant: SA Photonics, Inc., Los Gatos, CA (US)

(72) Inventors: David A. Pechner, San Jose, CA (US); Todd H. Chauvin, Sunnyvale, CA (US)

(21) Appl. No.: 17/543,644

(22) Filed: Dec. 6, 2021

Related U.S. Application Data
(60) Provisional application No. 63/122,259, filed on Dec. 7, 2020.

(51) Int. Cl. H04B 10/118; H04B 10/40

(52) U.S. Cl. CPC H04B 10/118; H04B 10/40

(57) ABSTRACT

The orbital states (position and/or time) for a constellation of space vehicles is determined as follows. The space vehicles measure PNT data, including range data determined based on FSO links between the space vehicles. The PNT data is transmitted from the space vehicles to two or more PNT controllers, which are a subset of the space vehicles that calculate the orbital state data for the constellation. This is a semi-distributed calculation. There is not a single controller that performs the calculations for all of the space vehicles in the constellation, and it is also not the case that each space vehicle performs its own calculations. Rather, each PNT controller services a sub-constellation of the space vehicles and determines the orbital state data for the space vehicles in the sub-constellation. The calculated orbital state data is transmitted from the PNT controllers to the space vehicles in the corresponding sub-constellations.

### CROSS-REFERENCE TO RELATED APPLICATION(S)

This application claims priority under 35 U.S.C. § 119(e) to U.S. Provisional Patent Application Ser. No. 63/122,259, “Positioning, Navigation, and Timing using Laser Ranging over Free Space Optical Links,” filed Dec. 7, 2020. The subject matter of all of the foregoing is incorporated herein by reference in their entirety.

### BACKGROUND

### 1. Technical Field

This disclosure relates generally to determining time and/or position of space vehicles in orbit.

### 2. Description of Related Art

A satellite in orbit typically must maintain certain information about its state in orbit in order to functional properly. Systems that provide or make use of this type of information are sometimes referred to as Positioning, Navigation, and Timing (PNT) systems. Positioning refers to the ability to determine a satellite's location in three dimensions relative to a selected frame of reference, for example an Earth-Centered, Earth-Fixed (ECEF) coordinate system. Navigation refers to the ability to use positioning information to determine relationships between the position of multiple satellites or between positions of one satellite at different times. Timing refers to the ability to determine a satellite's time relative to a selected time reference, for example clock offset between the satellite's local clock and Coordinated Universal Time (UTC). Timing may also include time transfer, which is the capability to transfer local knowledge of time from one location or system to another.

Ephemeris in this context is the position of a satellite over time. Traditionally, the ephemeris of a satellite may be determined based on on-board navigation systems and/or ranging to external known references, such as ground stations with known position and known time. However, as constellations of satellites become more common, it can be advantageous to determine the orbital state of satellites by also ranging to other satellites in the constellation.

### SUMMARY

Certain aspects relate to positioning, navigation, and/or timing using ranging over free space optical links within a constellation of space vehicles. In some embodiments, the orbital states (position and/or time) for a constellation of space vehicles is determined as follows. Space vehicles in the constellation measure PNT data, including range data determined based on free space optical (FSO links) between space vehicles. The PNT data is transmitted from the space vehicles to two or more PNT controllers, which are a subset of the space vehicles that calculate the orbital state data for the constellation. This is a semi-distributed calculation. There is not a single controller that performs the calculations for all of the space vehicles in the constellation, and each space vehicle also does not perform its own calculations. Rather, each PNT controller services a subset (sub-constellation) of the space vehicles and determines the orbital state data for the space vehicles in the sub-constellation. The calculated orbital state data is transmitted from the PNT controllers to the space vehicles in the corresponding sub-constellations and may also be transmitted to other space vehicles or recipients outside the constellation.

In one example, the constellation is defined by orbital planes, with multiple space vehicles in each orbital plane. One space vehicle in each orbital plane serves as the PNT controller for that orbital plane. It receives the PNT data measured by the other space vehicles in the orbital plane, calculates the orbital state data for the space vehicles and transmits the orbital state data to the space vehicles. The measured PNT data for each space vehicle includes FSO range data (i.e., range data determined based on FSO links) between that space vehicle and other space vehicles. For example, a space vehicle may measure FSO range data to the adjacent space vehicles in the same orbital plane and possibly also to space vehicles in adjacent orbital planes.

Other aspects include components, devices, systems, improvements, methods, processes, applications, computer readable mediums, and other technologies related to any of the above.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIG. 1A shows a constellation of space vehicles arranged in orbital planes.

FIG. 1B shows space vehicles in one orbital plane from FIG. 1A.

FIG. 1C shows FSO links between space vehicles in the constellation of FIG. 1A.

FIG. 2A is a diagram of FSO links between space vehicles in the constellation of FIG. 1.

FIG. 2B is a diagram of data flow from space vehicles to a PNT controller in the constellation of FIG. 1.

FIG. 2C is a diagram of data flow from a PNT controller to space vehicles in the constellation of FIG. 1.

FIG. 3A shows the measurement and transmission of PNT data from space vehicles in a sub-constellation to a local PNT controller.

FIG. 3B shows the calculation and transmission of orbital state data from the local PNT controller to the space vehicles in the sub-constellation.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

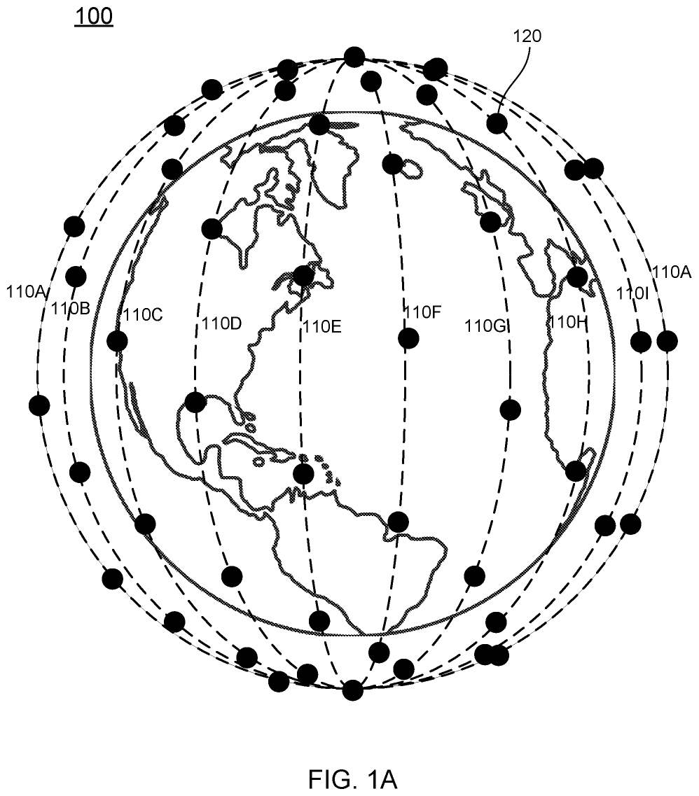

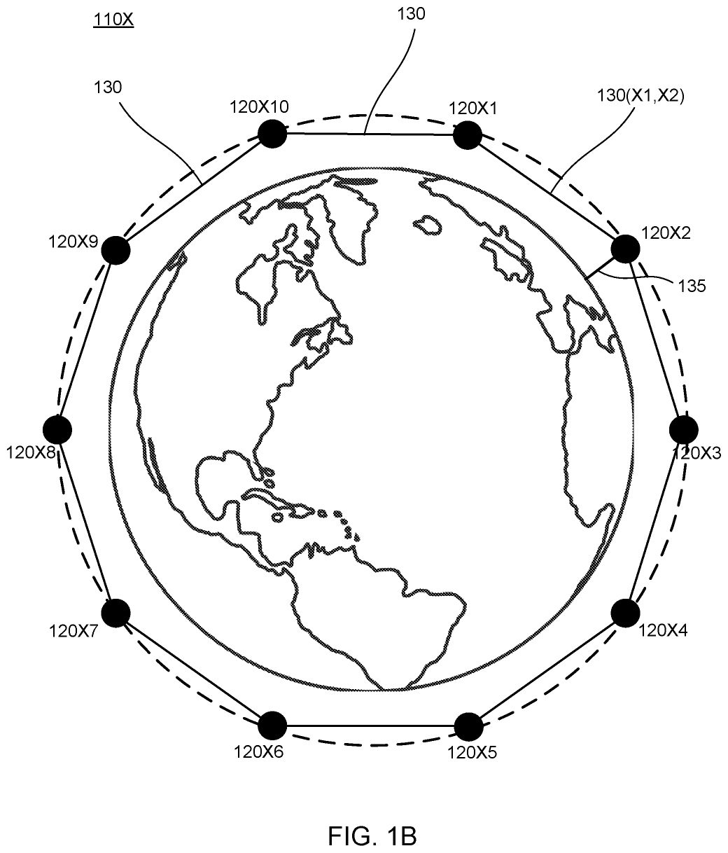

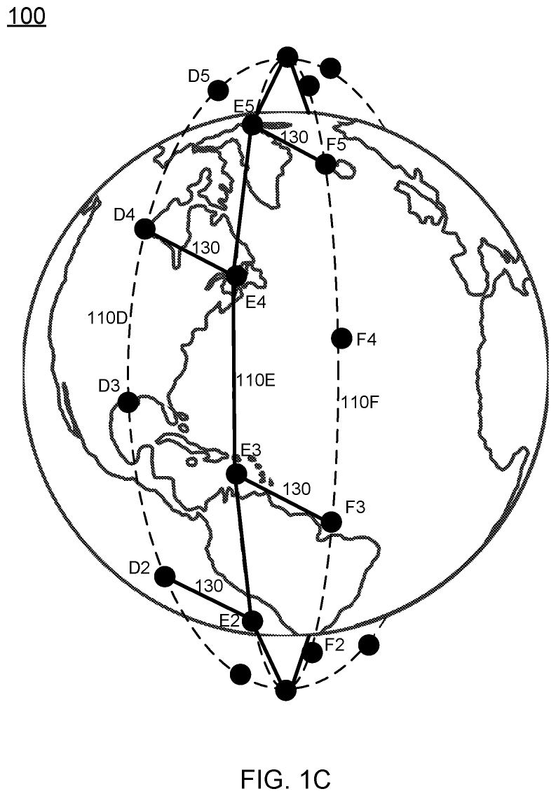

FIG. 1A shows a constellation 100 of space vehicles 120, denoted by solid circles, traveling along orbital planes 110. In this example, the space vehicles 120 are in polar orbit, with each orbital plane 110 oriented approximately along a different Right Ascension of the Ascending Node (RAAN). There are nine orbital planes 110A-110I, which are approximately evenly spaced by RAAN. There are ten satellites 120 in each orbital plane 110, which are approximately evenly spaced throughout the orbital plane. The individual satellites within an orbital plane are labelled 1-10, so individual satellites may be referred to as satellite 120XN or just XN, where X is the letter A-I referring to the orbital plane, and N is the number 1-10 referring to the specific satellite within the orbital plane. In FIG. 1A, the satellites 120 within the constellation 100 are approximately evenly distributed and provide approximately even coverage over the globe.

FIG. 1B shows the satellites 120X in one orbital plane 110X from FIG. 1A. In addition to the satellites 120X, the solid lines in FIG. 1B show FSO links 130 between adjacent satellites in the orbital plane. The FSO links 130 are used to obtain range data for the distances between satellites 120, which is then used to determine the orbital states of the satellites. FSO links 130X refer to the links within an orbital plane, and FSO link 130(a,b) refers to links between points a and b. For example, FSO link 130(X1,X2) is the link between satellites 120X1 and 120X2. In FIG. 1B, only link 130(X1,X2) is fully labeled, for convenience. FIG. 1B also shows an FSO link 135 between satellite 120X2 and a ground station. The ground station (or a series of ground stations) serve as a master reference for position and/or time for the satellites in the constellation.

FIG. 1C shows three adjacent orbital planes 110D-F and additional FSO links 130 between satellites in adjacent orbital planes. These will be referred to as cross-plane links, whereas the FSO links in FIG. 1B are referred to as in-plane links. In this constellation, each satellite has a counterpart satellite in the left and right adjacent orbital planes. For example, satellite E3 has counterpart satellites D3 and F3. The counterpart satellites travel together through their orbits. The cross-plane FSO links may include links to one or both of these nearest neighbor satellites. These cross-plane FSO links provide anchoring between orbital planes. Cross-plane FSO links may be turned off or discarded when the satellites cross the poles. FIG. 1C shows cross-plane links between satellite pairs E2-D2, E3-F3, E4-D4, and E5-F5.

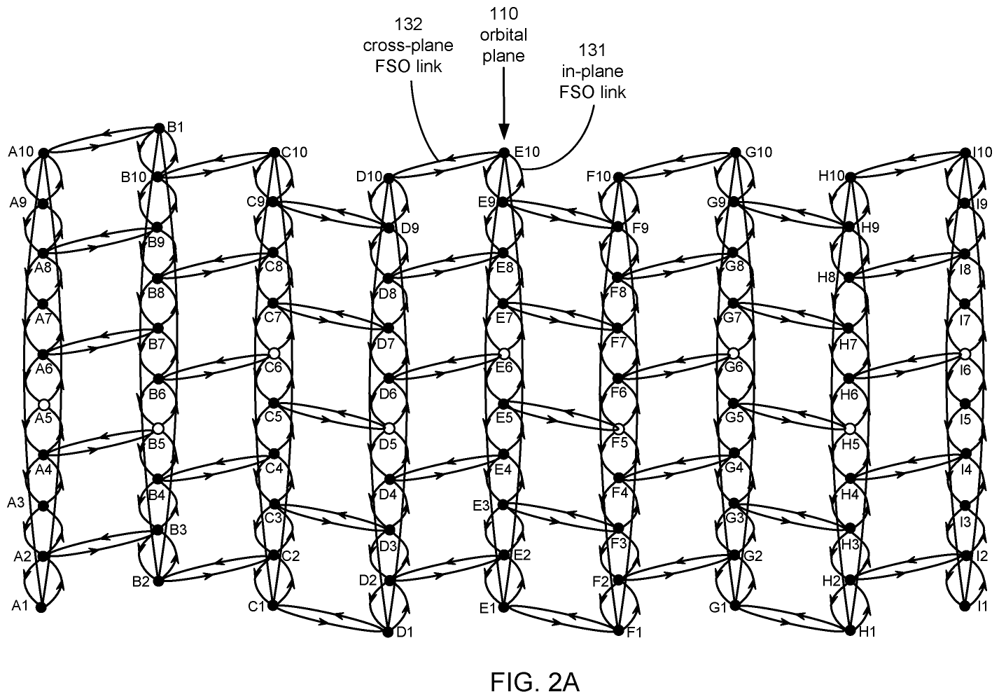

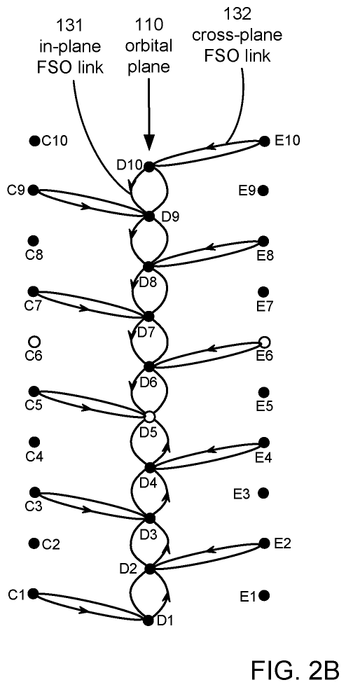

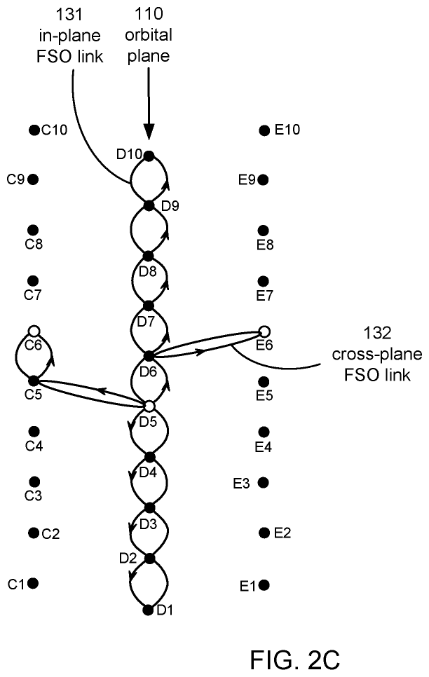

FIG. 2A is a diagram of FSO links between space vehicles in the constellation of FIG. 1. In this diagram, each circle represents a satellite A1-I10. Each column is an orbital plane 110. The arrows between satellites are FSO links. The FSO links include in-plane links 131, and cross-plane links 132. There are in-plane links 131 between all satellites in an orbital plane, including between satellites X1 and X10 for each orbital plane in FIG. 2A. Cross-plane links alternate left and right. Satellite E6 has a cross-plane link with D6 (but not F6), satellite E7 has a cross-plane link with F7 (but not D7), and so on. In this example, the FSO links are all bidirectional, although that is not required. Other patterns of FSO links between the satellites may be used.

Within each orbital plane 110, one of the satellites serves as a PNT controller for all of the satellites in that orbital plane. The satellites serviced by the PNT controller will be referred to as constituent satellites. In FIG. 2A, the PNT controllers A5, B5, C6, etc. are marked by hollow circles, rather than solid circles. The PNT controller receives the FSO range data and possibly other PNT data from the other satellites in the orbital plane, computes orbital state data (e.g., position and time) for the satellites in the orbital plane and then transmits the orbital state data to each of the satellites in the orbital plane. The communications between satellites may occur over the FSO links or over other communications links. The routing between the PNT controller and each of its constituent satellites may be direct or indirect via other satellites or nodes.

FIG. 2B shows data flow from various satellites to PNT controller D5. The PNT controller D5 collects PNT data from the other satellites D1-D10 in the same orbital plane. It also collects data from satellites in adjacent orbital planes. In this example, PNT data collected by satellites C1, C3, C5, C7, C9 and E2, E4, E6, E8, E10 are also transmitted to the PNT controller D5. The PNT controller D5 uses this data to determine the orbital state data for the other satellites D1-D10 in the same orbital plane.

FIG. 2C shows data flow for distribution of this orbital state data from PNT controller D5. Controller D5 distributes the orbital state data to the other satellites D1-D10 in the same orbital plane. It may also distribute the data to the PNT controllers C6 and E6 of the adjacent orbital planes, which in turn may further distribute the data to their constituent satellites and to the adjacent orbital planes.

This approach may be referred to as a semi-distributed approach. In a fully distributed approach, each satellite would receive the necessary PNT data and calculate its own orbital state data. However, this requires that each satellite have the capability and compute resources to do so. A semi-distributed approach may save some compute hardware on the non-controller satellites. The other extreme is a fully centralized approach, where a single satellite serves as the PNT controller for the entire constellation. All satellites would have to forward data to this central controller, and the calculated results are then distributed back to every satellite in the constellation. This can require more involved communications, longer latencies and larger accumulated errors.

FIG. 2 shows one example of a semi-distributed approach. Other examples will be apparent. For example, the PNT controllers may serve only to calculate orbital state data for other satellites and may not measure PNT data themselves.

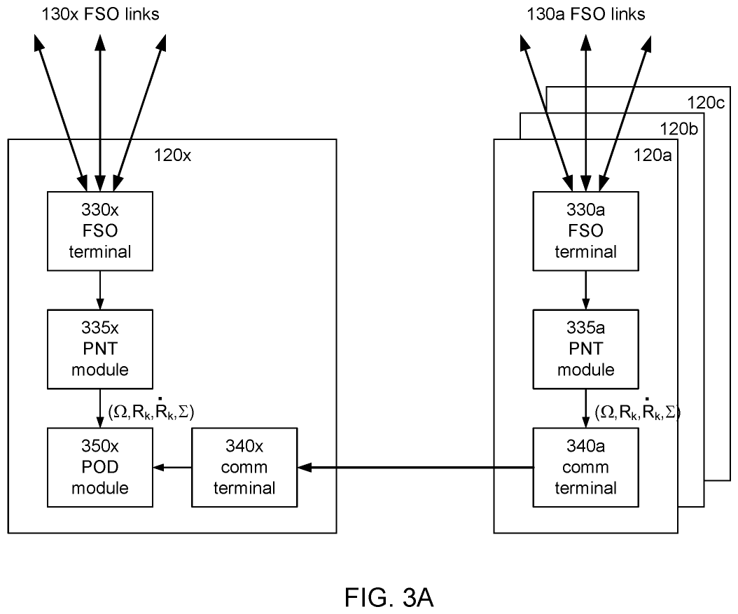

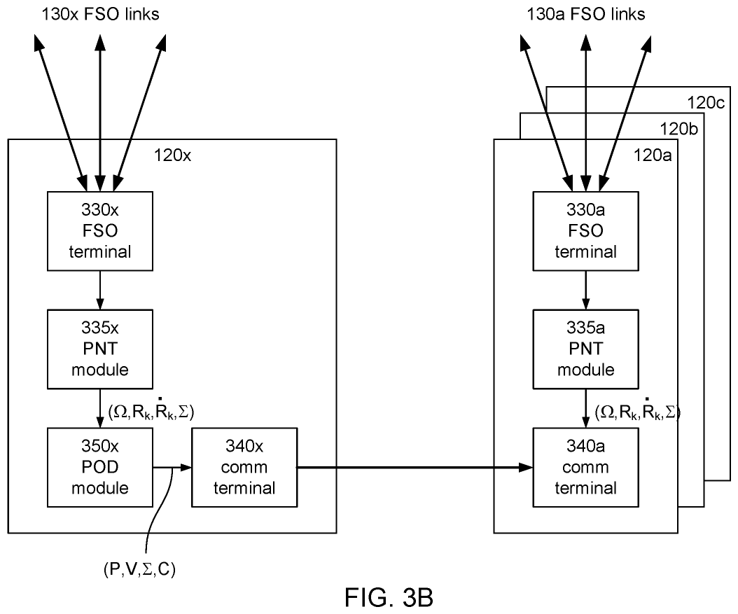

FIGS. 3A and 3B are block diagrams of satellites 120. FIG. 3A shows the measurement and transmission of PNT data from satellites 120 to a local PNT controller 120x. FIG. 3B shows the calculation and transmission of orbital state data from the local PNT controller 120x to the constituent satellites 120 in the sub-constellation.

The satellites 120, including PNT controller 120x, include an FSO terminal 330, a PNT module 335, and a communications terminal 340 (which may be the same as the FSO terminal 330). The FSO terminal 330 establishes FSO links 130 with other satellites, for example as shown in FIG. 2A. There may be multiple FSO terminals 330 to establish multiple FSO links.

The PNT module 335 receives data based on the FSO links 130 and may also receive additional other data. The module 335 determines PNT data, which is data used to calculate the orbital state data for the satellites. In this example, the PNT data for a satellite includes bearing (attitude and elevation) Ω of the FSO link, ranges Rₖ from that satellite to other satellites k, the rate of change of Rₖ, and covariance matrix Σ of the ranges.

Range may be estimated based on time of flight across the FSO link. Packets transmitted across the FSO link may be time stamped at the transmitting terminal and at the receiving terminal. Range between the two terminals may be estimated based on the difference between the two timestamps. This may be referred to as pseudo-range if the relative clock offset between the two terminals is not corrected. Rather than the range value, pairs of transmit and receive timestamps may be used as the range data. Range rate is the time rate of change of the range. These measurements may be made in a differential manner, particularly for satellites in the same orbital plane since the range between these satellites does not change as quickly as between other satellites. Using FSO links, ranges may be accurate to sub-cm resolution.

Synchronous range estimates may be made by using both directions of a bidirectional FSO link. That is, the range between two satellites 120a and 120b may be estimated based on (i) an FSO beam transmitted from satellite 120a to 120b, using the transmit time according to 120a's clock and the receive time according to 120b's clock; and (ii) an FSO beam simultaneously transmitted from 120b to 120a, using the transmit time according to 120b's clock and the receive time according to 120a's clock. Differences in time of flight for the two FSO beams are a measure of the relative clock offset between the clocks on satellites 120a and 120b.

Satellites may also make Doppler measurements, based on the frequency shift of FSO links transmitted from one satellite to another. Doppler measurements are a function of the relative velocity of two satellites.

Bearing of the FSO link is the direction in which the FSO link is pointing. Bearing may be measured based on tracking systems within the satellite. It may be measured by the FSO terminal relative to a satellite reference direction.

The PNT controller 120x also includes a precision orbit determination (POD) module 350x. The POD module 350x receives the PNT data from the satellites in that controller's sub-constellation, as shown in FIG. 3A. It calculates the corresponding orbital state data and transmits that data back to the constituent satellites in the sub-constellation, as shown in FIG. 3B, and may also transmit the data to other recipients of that data. In this example, the orbital state data for each constituent satellite includes position P and velocity V of that satellite, covariance matrix E (of P and V) and clock offset C relative to a reference time. In some implementations, the POD module 350x uses a Kalman filter to calculate the orbital state data. The PNT controller 350x may also transmit to the individual satellites (or other recipients) the ephemeris of all the satellites in the orbital plane or in the constellation. The PNT data and orbital state data preferably are updated at a rate of at least once per second.

Although the detailed description contains many specifics, these should not be construed as limiting the scope of the invention but merely as illustrating different examples. It should be appreciated that the scope of the disclosure includes other embodiments not discussed in detail above. For example, other constellations and arrangements of PNT controllers may be used. The implementation is semi-distributed if there is a total of at least two PNT controllers for the constellation, and each PNT controller services a sub-constellation of at least two of the space vehicles. Various other modifications, changes and variations which will be apparent to those skilled in the art may be made in the arrangement, operation and details of the method and apparatus disclosed herein without departing from the spirit and scope as defined in the appended claims. Therefore, the scope of the invention should be determined by the appended claims and their legal equivalents.

What is claimed is:

1. A method for determining orbital states for a constellation of space vehicles, the method comprising:
a plurality of the space vehicles in the constellation measuring PNT data, the PNT data comprising range data determined based on free space optical (FSO) links between space vehicles;
transmitting the PNT data from the plurality of space vehicles to a subset of space vehicles in the constellation that serve as PNT controllers for the constellation, wherein the constellation is served by a total of at least two PNT controllers and each PNT controller services a sub-constellation of at least two of the plurality of space vehicles; and
the PNT controllers calculating orbital state data for the space vehicles in the corresponding sub-constellations, the orbital state data comprising at least one of a position, velocity and time for the space vehicle

2. The method of claim 1 further comprising:
transmitting the orbital state data from the PNT controllers to the space vehicles in the corresponding sub-constellations.

3. The method of claim 1 further comprising:
transmitting the orbital state data from the PNT controllers to recipients outside the constellation.

4. The method of claim 1 wherein the plurality of space vehicles measuring PNT data includes the space vehicles serving as the PNT controllers.

5. The method of claim 1 wherein the constellation comprises a plurality of orbital planes, and one space vehicle in each orbital plane serves as the PNT controller for all of the space vehicles in that orbital plane.

6. The method of claim 1 wherein the range data for an individual space vehicle includes ranges between that space vehicle and other space vehicles, wherein the ranges are determined based on the FSO links between that space vehicle and the other space vehicles.

7. The method of claim 1 wherein the range data for an individual space vehicle includes pairs of transmit and receive timestamps for transmission over the FSO links to the individual space vehicle.

8. The method of claim 1 wherein each of the plurality of space vehicles measures and determines PNT data comprising bearing for FSO links with that space vehicle, ranges between that space vehicle and other space vehicles, and range rates for the ranges; and each of the plurality of space vehicles other than PNT controllers transmits its PNT data to the PNT controller servicing that space vehicle's sub-constellation.

9. The method of claim 8 wherein the ranges are accurate to sub-cm resolution.

10. The method of claim 1 wherein the orbital state data for an individual space vehicle includes position, velocity and clock offset for that space vehicle.

11. The method of claim 1 further comprising:
transmitting ephemeris of all the space vehicles in the constellation to the individual space vehicles in the constellation and/or to recipients outside the constellation.

12. The method of claim 1 further comprising:
transmitting data between space vehicles over the FSO links.

13. The method of claim 1 wherein the PNT data and orbital state data are updated at a rate of at least once per second.

14. A system comprising:
a constellation of space vehicles in orbit, wherein a subset of the space vehicles serve as PNT controllers for the constellation, the constellation includes a total of at least two PNT controllers, and each PNT controller services a sub-constellation of at least two of the space vehicles;
the space vehicles further comprising:
free space optical (FSO) terminals that implement FSO links between space vehicles; and
PNT modules that generate PNT data based on the FSO links, the PNT data comprising range data determined based on the FSO links between space vehicles; and
the PNT controllers further comprising:
communications terminals that receive PNT data from the space vehicles in the corresponding sub-constellations;
a POD module that calculates orbital state data for the space vehicles in the corresponding sub-constellations; and
wherein the communications terminals transmit the orbital state data from the PNT controllers to the space vehicles in the corresponding sub-constellations.

15. The system of claim 14 wherein the constellation comprises a plurality of orbital planes.

16. The system of claim 15 wherein one space vehicle in each orbital plane serves as the PNT controller for all of the space vehicles in that orbital plane.

17. The system of claim 15 wherein the FSO links for an individual space vehicle comprise in-plane FSO links to two adjacent space vehicles in the same orbital plane, and the FSO links for space vehicles in an individual orbital plane comprise cross-plane links to space vehicles in an adjacent orbital plane.

18. The system of claim 14 wherein the POD module includes a Kalman filter.

19. The system of claim 14 further comprising one or more ground stations that serve as reference nodes for the orbital state data.

20. The system of claim 14 wherein the FSO terminals are also the communications terminals.
